(19) United States
(12) Patent Application Publication
(10) Pub. No.: US 2017/0200113 A1
(43) Pub. Date: Jul. 13, 2017

(54) PLATFORM CONFIGURATION SELECTION BASED ON A DEGRADED MAKESPAN

(71) Applicant: Hewlett Packard Enterprise Development LP, Houston, TX (US)

(72) Inventor: Ludmila Cherkasova, Palo Alto, CA (US)

(21) Appl. No.: 15/320,844

(22) PCT Filed: Jul. 31, 2014
(86) PCT No.: PCT/US2014/049101

§ 371 Date: Dec. 21, 2016

(51) Int. Cl. G06Q 10/06; G06Q 10/10

(52) U.S. Cl. CPC G06Q 10/063118; G06Q 10/1053

(57) ABSTRACT

A method, system, and computer-readable storage device for selecting a platform configuration in light of a degraded makespan is described herein. A job profile of a prospective job, a normal makespan goal, and a degraded makespan goal may be obtained. The job profile may include a job trace summary. A simulation result of the prospective job may be generated based on a first simulation of the job trace summary on a platform configuration and a second simulation of the job trace summary on a degraded version of the platform configuration. The simulation result may include a predicted normal makespan and a predicated degraded makespan. The platform configuration may then be selected. In some cases the platform configuration may be selected via a purchasing option sent to a tenant.

### BACKGROUND

A cloud infrastructure can include various resources, including computing resources, storage resources, and/or communication resources, that can be rented by customers (also referred to as tenants) of the provider of the cloud infrastructure. By using the resources of the cloud infrastructure, a tenant does not have to deploy the tenant's own resources for implementing a particular platform for performing target operations. Instead, the tenant can pay the provider of the cloud infrastructure for resources that are used by the tenant. The “pay-as-you-go” arrangement of using resources of the cloud infrastructure provides an attractive and cost-efficient option for tenants that do not desire to make substantial up-front investments in infrastructure.

### BRIEF DESCRIPTION OF THE DRAWINGS

The following description illustrates various examples with reference to the following figures:

FIG. 1 is a schematic diagram of a cloud infrastructure service, according to an example;

FIG. 2 is a block diagram illustrating example components of the evaluation system, according to some implementations;

FIG. 3 is a flowchart that illustrates a method for selecting a platform configuration for a job or a workload of jobs, in accordance to an example;

FIG. 4 is a flowchart that illustrates the operation of generating simulation results of FIG. 3 in greater detail, according to an example implementation;

FIGS. 5 and 6A-6B illustrate execution orders of jobs, according to some examples;

FIG. 7 is a diagram which shows an scheduling queue that includes a number of entries in which jobs of the set [symbol] of jobs are to be placed; and

FIG. 8 is a block diagram of a computing device capable of selecting a platform configuration in light of a failure case, according to one example.

### DETAILED DESCRIPTION

A cloud infrastructure can include various different types of computing resources that can be utilized by or otherwise provisioned to a tenant for deploying a computing platform for processing a workload of a tenant. A tenant can refer to an individual or an enterprise (e.g., a business concern, an educational organization, or a government agency). The computing platform (e.g., the computing resources) of the cloud infrastructure are available and accessible by the tenant over a network, such as the Internet, a local area network (LAN), a wide area network (WAN), a virtual private network (VPN), and so forth.

Computing resources can include computing nodes, where a “computing node” can refer to a computer, a collection of computers, a processor, or a collection of processors. In some cases, computing resources can be provisioned to a tenant according to determinable units offered by the cloud infrastructure system. For example, in some implementations, computing resources can be categorized into computing resources according to processing capacity of different sizes. As an example, computing resources can be provisioned as virtual machines (formed of machine-readable instructions) that emulate a physical machine. A virtual machine can execute an operating system and applications like a physical machine. Multiple virtual machines can be hosted by a physical machine, and these multiple virtual machines can share the physical resources of the physical machine. Virtual machines can be offered according to different sizes, such as small, medium, and large. A small virtual machine has a processing capacity that is less than the processing capacity of a medium virtual machine, which in turn has less processing capacity than a large virtual machine. As examples, a large virtual machine can have twice the processing capacity of a medium virtual machine, and a medium virtual machine can have twice the processing capacity of a small virtual machine. A processing capacity of a virtual machine can refer to a central processing unit (CPU) and memory capacity, for example.

A provider of a cloud infrastructure can charge different prices for use of different resources. For example, the provider can charge a higher price for a large virtual machine, a medium price for a medium virtual machine, and a lower price for a small virtual machine. In a more specific example, the provider can charge a price for the large virtual machine that is twice the price of the medium virtual machine. Similarly, the price of the medium virtual machine can be twice the price of a small virtual machine. Note also that the price charged for a platform configuration can also depend on the amount of time that resources of the platform configuration are used by a tenant.

Also, the price charged by a provider to a tenant can vary based on a cluster size by the tenant. If the tenant selects a larger number of virtual machines to include in a cluster, then the cloud infrastructure provider may charge a higher price to the tenant, such as on a per virtual machine basis.

The configuration of computing resources selected by a tenant, such as a processor sizes, virtual machines, computer nodes, network bandwidth, storage capacity, and the like may be referred to as a platform configuration. The choice of the platform configuration can impact the cost or service level of processing a workload.

A tenant is thus faced with a variety of choices with respect to resources available in the cloud infrastructure, where the different choices are associated with different prices. Intuitively, according to examples discussed above, it may seem that a large virtual machine can execute a workload twice as fast as a medium virtual machine, which in turn can execute a workload twice as fast as a small virtual machine. Similarly, it may seem that a 40-node cluster can execute a workload four times as fast as a 10-node cluster.

As an example, the provider of the cloud infrastructure may charge the same price to a tenant for the following two platform configurations: (1) a 40-node cluster that uses 40 small virtual machines; or (2) a 10-node cluster using 10 large virtual machines. Although it may seem that either platform configuration (1) or (2) may execute a workload of a tenant with the same performance, in actuality, the performance of the workload may differ on platform configurations (1) and (2). The difference in performance of a workload by the different platform configurations may be due to constraints associated with network bandwidth and persistent storage capacity in each platform configuration. A network bandwidth can refer to the available communication bandwidth for performing communications among computing nodes. A persistent storage capacity can refer to the storage capacity available in a persistent storage subsystem.

Increasing the number of computing nodes and the number of virtual machines may not lead to a corresponding increase in persistent storage capacity and network bandwidth. Accordingly, a workload that involves a larger amount of network communications would have a poorer performance in a platform configuration that distributes the workload across a larger number of computing nodes and virtual machines, for example. Since the price charged to a tenant may depend in part on an amount of time the resources of cloud infrastructure are reserved for use by the tenant, it may be beneficial to select a platform configuration that reduces the amount of time that resources of the cloud infrastructure are reserved for use by the tenant.

Selecting a platform configuration in a cloud infrastructure can become even more challenging when a performance objective is to be achieved. For example, one performance objective may be to reduce (or minimize) the overall completion time (referred to as a “makespan”) of the workload. A makespan may be measured from the time a workload begins to when the workload is completed.

In some cases, a tenant may define a performance objective for cases where a failure occurs within the cloud infrastructure hosted by the cloud provider. Such may occur, for example, when the tenant executes a MapReduce cluster on virtual machines instantiated on the cloud infrastructure but one of those virtual machines fails. In some cases, tenants may have difficulty assessing how a given platform configuration may operate in light of such a failure. Such may be the case because a failure of a large instance of a virtual machine that is a node within a Hadoop cluster might have a more severe performance impact compared to a loss of a small instance of a virtual machine in a Hadoop cluster.

In accordance with some implementations, techniques or mechanisms are provided to allow for selection of a platform configuration, from among multiple platform configurations, that is able to satisfy an objective of a tenant of a cloud infrastructure. For example, according to an example implementation, obtain a job profile of a prospective job, a normal makespan goal, and a degraded makespan goal. The job profile may include a job trace summary. A simulation result of the prospective job may be generated based on a first simulation of the job trace summary on a platform configuration and a second simulation of the job trace summary on a degraded version of the platform configuration. The simulation result may include a predicted normal makespan and a predicated degraded makespan. The platform configuration may then be selected. In some cases the platform configuration may be selected via a purchasing option sent to a tenant.

In another example, job profiles of prospective jobs in a workload, a normal makespan goal, and a degraded makespan goal may be obtained. The job profiles may include job trace summaries. A schedule of the workload may then be generated using the job trace summaries and a platform configuration. A simulation result of an execution of the workload according to the schedule and the platform configuration may be aggregated with a simulation result of another execution of the workload according to the schedule and a degraded version of the platform configuration. The aggregated simulation result including a predicted normal makespan and a predicated degraded makespan. The platform configuration may be selected based on the predicted normal makespan satisfying the normal makespan goal and the predicted degraded makespan satisfying the degraded makespan goal. Computing resources from a cloud infrastructure system may then be provisioned according to the selected platform configuration.

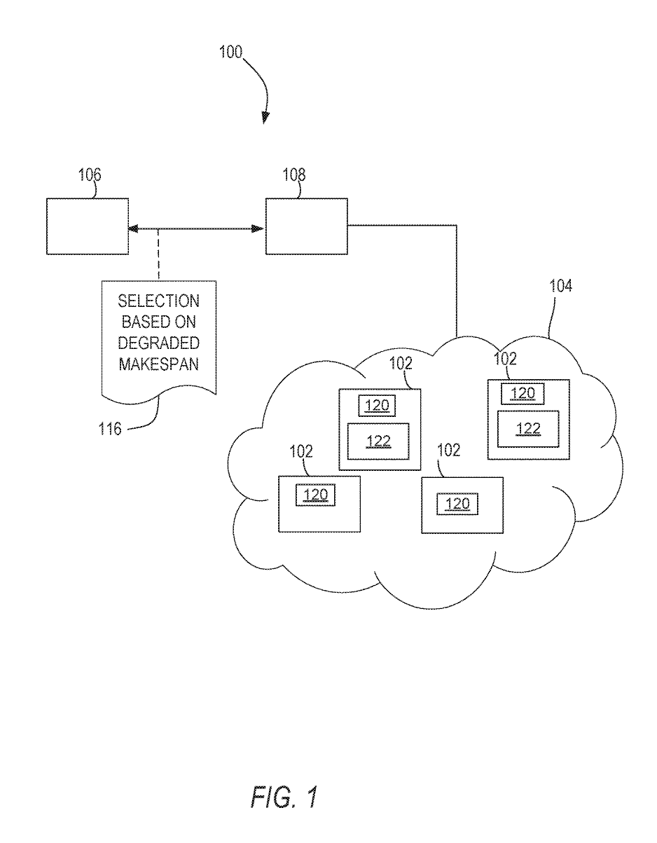

FIG. 1 is a schematic diagram of a cloud infrastructure service 100, according to an example. The cloud infrastructure service 100 includes a tenant system 106, an evaluation system 108, and a cloud infrastructure system 104. The cloud infrastructure system 104 can include computing nodes 102 communicatively coupled by a network. As described above, a computing node may be a computer, a collection of computers, a processor, or a collection of processors. A provider of the cloud infrastructure system 104 may partition computing resources from the computing nodes 102 and rent out those resources to the tenant system 106. For example, as shown in FIG. 1, each of the computing nodes 102 includes a number of virtual machines (\Ms), such as virtual machines 120, 122. The virtual machines 120, 122 may be a partitioning of computing resource that is dedicated for a given tenant. The virtual machines may differ according to the underlying computer resources of the computing node that hosts the virtual machine. For example, the virtual machines 120 may be allocated a given amount of processor bandwidth, storage, or any other compute resource, while the virtual machines 122 may be allocated a different amount of processor bandwidth, storage, or any other compute resource.

The tenant system 106 is communicatively coupled to the cloud infrastructure system 104. A tenant system can refer to a computer or collection of computers associated with a tenant. Through the tenant system 106, a tenant can submit a request to the cloud infrastructure service 100 to rent the resources of the cloud infrastructure service 100 through, for example, virtual machines executing on the computing nodes 102. A request for resources of the cloud infrastructure service 100 can be submitted by a tenant system 106 to an evaluation system 108 of the cloud infrastructure service 100. The request can identify a workload of jobs to be performed, and can also specify target makespans (e.g., a normal case makespan or a degraded case makespan) and/or a cost the tenant is willing to spend on executing a workload.

The evaluation system 108 may be a computer system that interfaces with the tenant system 106 and the cloud infrastructure system 104. The evaluation system 108 may be a computer system that is configured to select a platform configuration from among multiple platform configurations that can be hosted on the cloud infrastructure system 104 based on a degraded makespan target. In some cases, a selection of a platform configuration can be presented in a purchasing option 116 that the tenant can use to purchase computing resources from the cloud infrastructure system 104. The purchasing, option 116 may include a selection of a platform configuration where the selection is based on a degraded makespan. Example methods and operations for selecting a platform configuration is discussed in greater detail below. Once the platform configuration is selected by the platform configuration selector 116 (as may be initiated by a tenant through the purchasing option 116), the selected resources that are part of the selected platform configuration (including a cluster of computing nodes 102 of a given cluster size, and virtual machines of a given size) are made accessible to the tenant system 106 to perform a workload of the tenant system 106.

By way of example and not limitation, the tenant system 106 may rent computing resources from the cloud infrastructure system 104 to host or otherwise execute a workload that includes MapReduce jobs. Before discussing further aspects of examples of the cloud infrastructure service 100, MapReduce is now discussed. MapReduce jobs operate according to a MapReduce framework that provides for parallel processing of large amounts of data in a distributed arrangement of machines, such as virtual machines 120, as one example. In a MapReduce framework, a MapReduce job is divided into multiple map tasks and multiple reduce tasks, which can be executed in parallel by computing nodes. The map tasks operate according to a user-defined map function, while the reduce tasks operate according to a user-defined reduce function. In operation, map tasks are used to process input data and output intermediate results. Reduce tasks take as input partitions of the intermediate results to produce outputs, based on a specified reduce function that defines the processing to be performed by the reduce tasks. More formally, in some examples, the map tasks process input key-value pairs to generate a set of intermediate key-value pairs. The reduce tasks produce an output from the intermediate key-value pairs. For example, the reduce tasks can merge the intermediate values associated with the same intermediate key.

Although reference is made to MapReduce jobs in the foregoing, it is noted that techniques or mechanisms according to some implementations can be applied to select platform configurations for workloads that include other types of jobs.

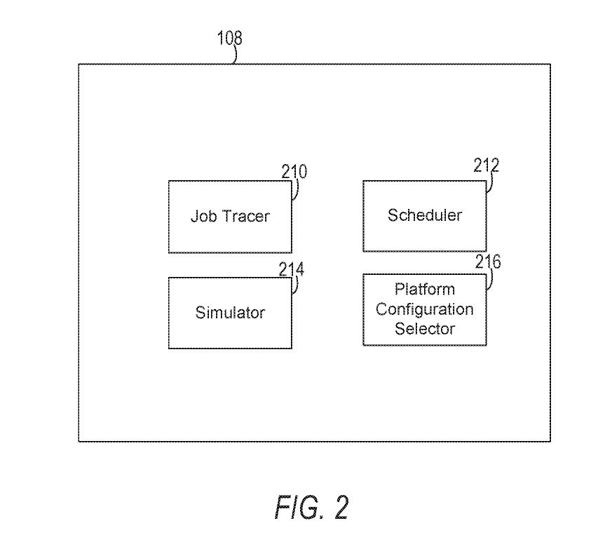

FIG. 2 is a block diagram illustrating example components of the evaluation system 108, according to some implementations. The evaluation system 108 shown in FIG. 2 includes a job tracer 210 to produce job trace summaries, a scheduler 212 to generate an execution order for jobs of a workload, a simulator 214 to simulate the execution of jobs of a workload on a candidate platform configuration that includes a given cluster of computing virtual machines executing on compute nodes, and a platform configuration selector 216 to select a platform configuration to achieve a target object.

Although FIG. 2 depicts the job tracer 210, the scheduler 212, the simulator 214, and the platform configuration selector 216 as being part of the evaluation system 108, it is noted that in other implementations, the job tracer 210, the scheduler 212, the simulator 214, or the platform configuration selector 216 can be modules of systems other than the evaluation system 108, such as the cloud infrastructure system 104.

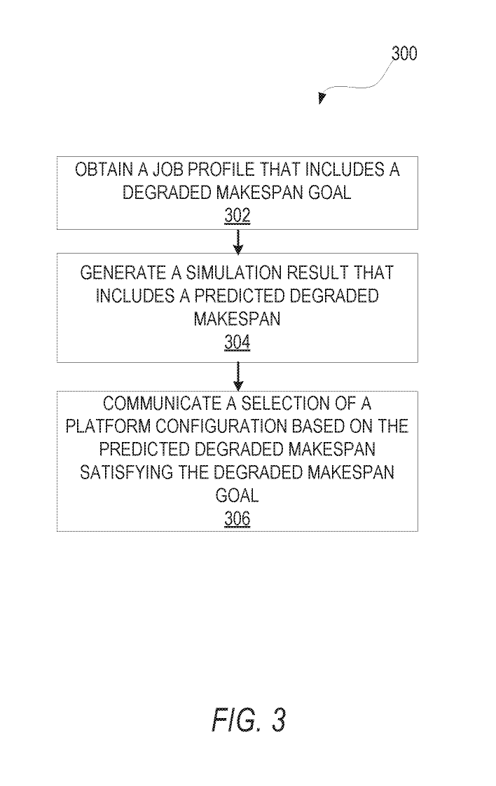

FIG. 3 is a flowchart that illustrates a method 300 for selecting a platform configuration for a job (or a workload that includes multiple jobs), in accordance to an example. The method 300 may be performed by the modules, logic, components, or systems shown in FIGS. 1 and 2 and, accordingly, is described herein merely by way of reference thereto. It will be appreciated that the method 300 may, however, be performed on any suitable hardware.

The method 300 may begin at operation 302 when the platform configuration selector 216 obtains a job profile of a prospective job, a normal makespan goal, and a degraded makespan goal from the tenant system 106. In some cases, the job profile may include a job trace summary. A job trace summary may be data or logic that characterizes the execution properties of the jobs (or comprising tasks) that are part of the workload. For MapReduce frameworks, a job trace summary can include data that represents a set of measured durations of map and reduce tasks of a given job on a given platform configuration.

The normal makespan goal may be data and/or logic that represents a tenant specified goal of a duration of time in which the cloud infrastructure system 104 can start and complete a job if the cloud infrastructure system 104 does not experience any faults during execution of the workload. The degraded makespan goal may be data and/or logic that represents a tenant specified goal of a duration of time in which the cloud infrastructure system 104 can start and complete a job where the cloud infrastructure system 104 experiences a fault during execution of the workload. The normal makespan goal and the degraded makespan goal may each be input supplied by a tenant.

At operation 304, the simulator 214 may generate a simulation result of the prospective job based on multiple simulations of the job trace summary, where each simulation of the job trace summary simulates an execution of the prospective job on a different version of a platform configuration. For example, the job trace summary may be simulated to execute on a version of the platform configuration that represents a normal case. In parallel, or sequentially, the job trace summary may be simulated to execute on another version of the platform configuration that represents a degraded case (e.g., where a node fails), relative to the version of the platform configuration representing the normal case. These simulations may be used to generate a predicted normal makespan and a predicated degraded makespan. To illustrate further, the simulator 214 may execute a simulation of the job on a platform configured with 20 small nodes. This platform configuration may represent a normal case platform configuration, and the simulation of the job on this platform configuration may produce a predicted normal makespan. The simulator 214 may execute another simulation of the job on a degraded version of the normal case platform configuration, such as a platform configuration specifying 19 small nodes, which may represent a single node failure of the normal case platform configuration. The simulation of the job on the degraded version of the normal case platform configuration may produce a predicted degraded makespan.

At operation 306, the platform configuration selector 216 may select a platform configuration for the tenant system 106. The platform configuration selector 216 may select the platform configuration based on the predicted normal makespan of the platform configuration satisfying the normal makespan goal and the predicted degraded makespan of the platform configuration satisfying the degraded makespan goal. The platform configuration selector 216 may communicate the selected platform configuration to the tenant system in a purchasing option (e.g., such as the purchasing option 116 in FIG. 1). In some cases, the purchasing option may be configured such that when the tenant system 106 selects or otherwise activates the purchasing option, the cloud infrastructure system 104 provisions VMs according to the platform configuration selected by the purchasing option.

Accordingly, the evaluation system 108 may provide a tenant with a comparatively simple mechanism to select a platform configuration to execute a job or a workload of jobs on a cloud infrastructure.

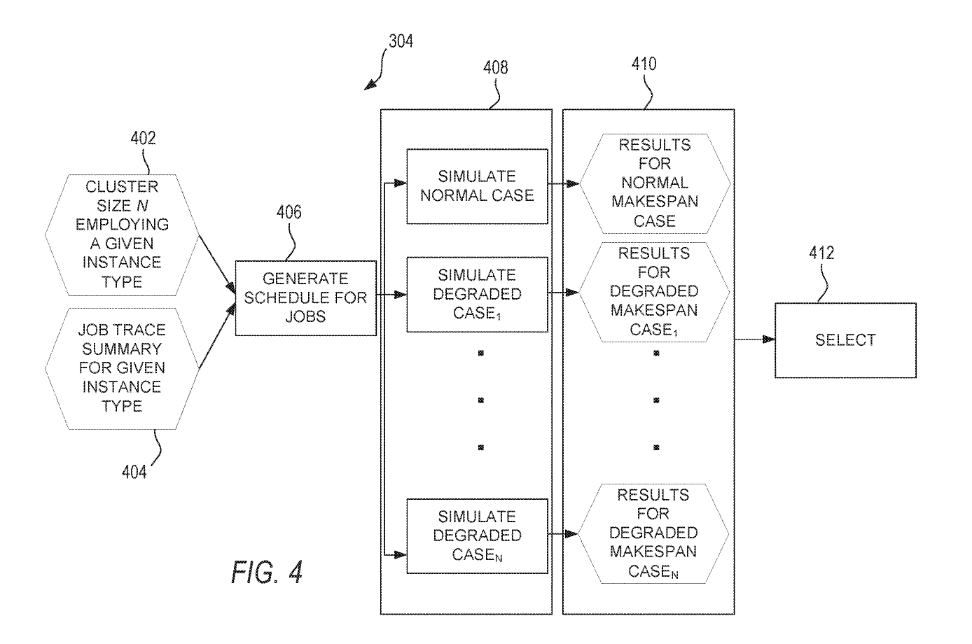

FIG. 4 is a flowchart that illustrates operation 304 in greater detail, according to an example implementation. In the example implementation shown in FIG. 4, the scheduler 212 may, at operation 406, generate a schedule of jobs in a workload. In some cases, to generate the schedule, the scheduler 212 uses a platform configuration 402 and a job trace summary 404. In some cases the platform configuration 402 specifies a cluster size and of a given instance type for a MapReduce cluster that will execute the workload. In some cases, properties of the platform configuration (e.g., cluster size (as may be represented by a number of virtual machines), instance type, or any other suitable type of computer resource) may be specified by the tenant, programmatically selected by the platform configuration selector 216, or the like.

The job trace summary 404 may include data or logic that characterizes the execution properties of the jobs that are part of the workload. For MapReduce frameworks, a job trace summary can include data that represents a set of measured durations of map and reduce tasks of a given job on a given platform configuration. The data or logic of the job trace summary can be created for the platform configurations supported by the cloud infrastructure, which can differ, in some cases, by instance type (e.g. different sizes of virtual machines or physical machines) or by cluster sizes, for example. Using the job trace summary, data regarding the tasks of a job can be computed. For example, an average duration and/or maximum duration of map and reduce tasks of each job can be computed. The job trace summaries can be obtained in multiple ways, depending on implementation. For example, the job trace summaries may be obtained, from the job tracer 210: a) from the past run of this job on the corresponding platform (the job execution can be recorded on the arbitrary cluster size)], b) extracted from the sample execution of this job on the smaller dataset, or, c) interpolated by using a benchmarking approach.

In some implementations of operation 406, the scheduler 212 produces a schedule (that includes an order of execution of jobs and respective tasks) that reduces (or minimizes) an overall completion time of a given set of jobs. In some examples, a Johnson scheduling technique for identifying a schedule of concurrent jobs can be used. In general, the Johnson scheduling technique may provide a decision rule to determine an ordering of tasks that involve multiple processing stages. In other implementations, other techniques for determining a schedule of jobs can be employed. For example, the determination of an improved schedule can be accomplished using a brute-force technique, where multiple orders of jobs are considered and the order with the best or better execution time (smallest or smaller execution time) can be selected as the optimal or improved schedule.

With continued reference to FIG. 4, after the scheduler 112 generates a schedule for the workload, the simulator 214 may, at operation 408, execute a number of simulations of the schedule of jobs executing on the platform configuration 402 and variations of the platform configuration 402 that represent a degraded case. For example, the simulator 214 may execute a simulation of the schedule for the jobs on the platform configuration 402 and another simulation of the schedule for the jobs on a variation of the platform configuration 402, where the variation of the platform configuration specifies a node cluster with one less node to represent a one node failure case. As FIG. 4 shows, the simulator 214 may execute additional simulations for other variants of the platform configuration to represent other degraded cases, such as a two node failure, a three node failure, and so on.

The results of the multiple simulations executed at operation 408 may form a data record 410. A data record may include one or more of the following fields: (InstType, NumNodes, Sated, Makespan_{Nml}, Cost _{Nml}, Makespan _{Flt}, Cost _{Flt}), where InstType specifies an instance type (e.g., a virtual machine size); NumNodes specifies the cluster size (number of computing nodes in a cluster); Sched specifies an order of the jobs of the workload; Makespan_{Nml} specifies the predicted makespan of the workload of jobs in the normal case (no faults are present); Cost_{Nml} represents the cost to the tenant to execute the jobs of the workload with the platform configuration (including the respective cluster size and instance type), where the cost can be based on the price charged to a tenant for the respective platform configuration for a given amount of time; Makespan_{Flt}, specifies the predicted makespan of the workload of jobs in a faulty case (e.g., one node fault); Cost_{Flt} represents the cost to the tenant to execute the jobs of the workload with the platform configuration in the faulty case, where, again, the cost can be based on the price charged to a tenant for the respective platform configuration for a given amount of time.

In some cases, the operation 304 shown in FIG. 4 may iterate over different platform configurations to generate additional data records. For example, some implementations of the operation 304 may iterate over operations 406, 408 multiple times where each subsequent iteration updates the platform configuration by incrementing the size of the cluster. For each iteration of operation 406, 408, the scheduler 112 produces a new job schedule for the increased cluster size. Further, for each iteration of operation 406, 403, the simulator 214 simulates the job trace summary using the new schedule and the updated platform configuration and simulates the job trace summary using the new schedule and degraded versions of the updated platform configuration. These simulations generate predicted normal case makespans and degraded case makespans for the update platform configurations, which are added as a new data record in the search space. In this way, the operation 304 may add additional data records to the search space for platform configurations with varying duster sizes. The operation 304 can iterate over operations 406, 408 in this way until a stopping condition is detected. In some examples, a stopping condition can include one of the following: (1) the iterative process is stopped once cluster sizes from a predetermined range of values for a cluster size have been considered; or (2) the iterative process is stopped if an increase in cluster size does not improve the achievable makespan by greater than some specified threshold. The latter condition can happen when the cluster is large enough to accommodate concurrent execution of the jobs of the workload, and consequently, increasing the cluster size cannot improve the makespan by a substantial amount.

Aside from iterating over cluster size, the operation 304 can iterate over instance types. For example, the operations 406, 408 can be performed for another instance type (e.g. another size of virtual machines), which further adds data records to the search space that correlate various instance types with respective performance metrics (e.g., normal case makespan and degraded case makespans).

After the search space has been built, the platform configuration selector 216 may, at operation 412, select a data record from the search space. In some examples, the platform configuration selector 216 can be used to solve at least one of the following problems: (1) given a target makespan T specified by a tenant, select the platform configuration that minimizes the cost; or (2) given a target cost C specified by a tenant, select the platform configuration that minimizes the makespan.

To solve problem (1), the following procedure can be performed.
1) Sort the data set Data J)=(InstType, NumNodes, Sched, Makespan_{Nml}, Cost_{Nml}, Makespan_{Flt}, Cost _{Flt}) by the Makespan_{Nml} values in non-descending order.
2) Form a subset Data_{Makespan}_{_{Nml}}_{≦}_{_{Nml}} (J) of the data set Data (J), in which the entries of the subset Data_{Makespan}_{_{Nml}}_{≦}(J) satisfy Makespan_{Nml}≦T_{Nml}, where T_{Nml} is a target makespan specified by a tenant. Stated differently, the entries of the data set Data(J) whose Makespan_{Nml} values exceed T_{Nml} are excluded from the subset Data_{Makespan}_{_{Nml}}_{≦}_{_{Nml}} (J).
3) Sort the data set Data_{Makespan}_{_{Nml}}_{≦}_{_{Nml}} (J) by the Makespan_{Flt} values in non-descending order.
4) Form a subset Data_{Makespan}_{_{Flt}}_{≦}_{_{Flt}} (J) of the data set Data_{Makespan}_{_{Nml}}_{≦}_{_{Nml}} (J), in which the entries of the subset Data_{Makespan}_{_{Flt}}_{≦}_{_{Flt}} (J) satisfy Makespan_{Flt}≦T_{Flt}, where T_{Flt} is a target makespan specified by a tenant. Stated differently, the entries of the data set Data_{Makespan}_{_{Nml}}_{≦}_{_{Nml}} (J) whose Makespan_{Flt} values exceed T_{Flt} are excluded from the subset Data_{Makespan}_{_{Flt}}_{≦}_{_{Flt}} (J).
5) Sort the subset Data_{Makespan}_{_{Flt}}_{≦}_{_{Flt}} (J) by the Cost_{Flt} values in non-descending order.
6) Select an entry (or entries) in the subset Data_{Makespan≦T} ^{minCost} (J) with a low cost. The selected entry (or entries) represent(s) the solution, i.e. a platform configuration of a corresponding instance type and cluster size. Each selected entry can also be associated with a schedule, which can also be considered to be part of the solution. The solution satisfies the target makespan T_{Nml} while reducing (or minimizing) the cost in such a way that if a node faults, the jobs are processed (e.g., completed) within a degraded time limit (e.g., T_{Flt}).

The foregoing further describes determining a schedule of jobs of a workload, according to some implementations, which was introduced above with reference to operation 406. For a set of MapReduce jobs (with no data dependencies between them), the order in which the jobs are executed may impact the overall processing time, and thus, utilization and the cost of the rented platform configuration (note that the price charged to a tenant can also depend on a length of time that rented resources are used—thus, increasing the processing time can lead to increased cost).

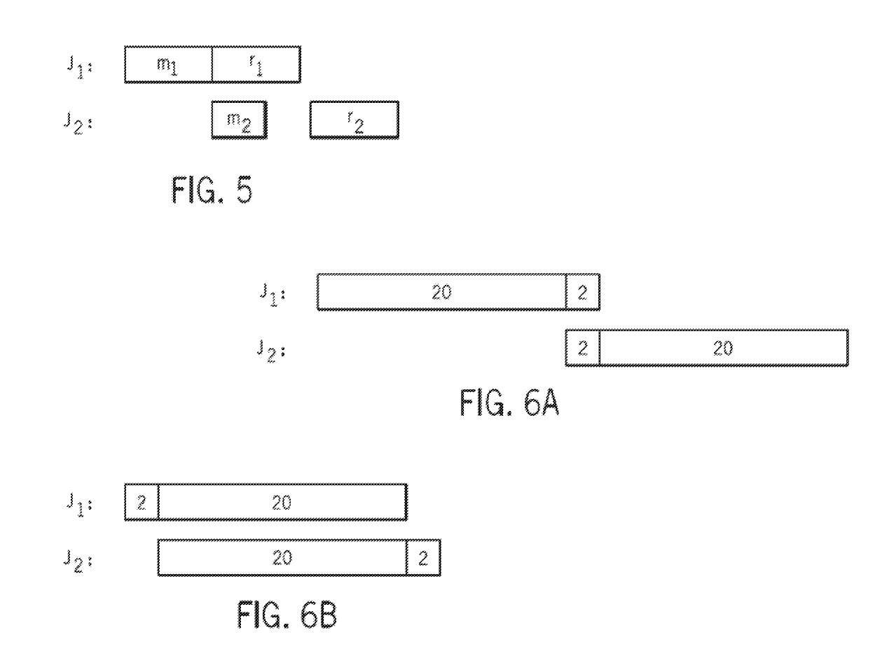

The following considers an example execution of two (independent) MapReduce jobs J₁ and J₂ in a cluster, in which no data dependencies exist between the jobs. As shown in FIG. 5, once the map stage (m₁) of J₁ completes, the reduce stage (r₁) of J₁ can begin processing. Also, the execution of the map stage (m₂) of the next J₂ can begin execution, by using the map resources released due to completion of the map stage (m₁) of J₁. Once the map stage (m₂) of the next job J₂ completes, the reduce stage (J₂) of the next job J₂ can begin. As shown in FIG. 5, there is an overlap in executions of map stage (m₂) of job J₂ and the reduce stage (r₁) of job J₁.

A first execution order of the jobs may lead to a less efficient resource usage and an increased processing time as compared to a second execution of the jobs. To illustrate this, consider an example workload that includes the following two jobs:
Job J₁=(m₁, r₁)=(20 s, 2 s) (map stage has a duration of 20 seconds, and reduce stage has a duration of two seconds).
Job J₂=(m₂, r₂)=(2 s,20 s) (map stage has a duration of two seconds, and reduce stage has a duration of 20 seconds).

There are two possible execution orders for jobs J₁ and J₂ shown in FIGS. 6A and 6B:
J₁ is followed by J₂ (FIG. 6A). In this execution order, the overlap of the reduce stage of J₁ with the map stage of J₁ extends two seconds. As a result, the total completion time of processing jobs J₁ and J₂ is 20s+2s+20s=42s.
J₂ is followed by J₁ (FIG. 6B). In this execution order, the overlap of the reduce stage of h with the map stage of J₁ extends 20 seconds. As a result, the total completion time is 2s+20s+2s=24s, which is less than the first execution order.

More generally, there can be a substantial difference in the job completion time depending on the execution order of the jobs of a workload. A workload [symbol] ={J₁, J₂, . . . , Jₙ} includes a set of n MapReduce jobs with no data dependencies between them. The scheduler 214 generates an order (a schedule) of execution of jobs Jᵢ ∈ [symbol] such that the makespan of the workload is minimized. For minimizing the makespan of the workload of jobs [symbol] ={J₁, J₂, . . . , Jₙ}, the Johnson scheduling technique can be used.

Each job Jᵢ in the workload [symbol] of n jobs can be represented by the pair (mᵢ, rᵢ) of map and reduce stage durations, respectively. The values of mᵢ and rᵢ can be estimated using lower and upper bounds, as discussed above, in some examples. Each job Jᵢ=(mᵢ, rᵢ) can be augmented with an attribute Dᵢ that is defined as follows:

$${D}_{i} = \{ \begin{matrix}( {m}_{i} , m ) & if min ( {m}_{i} , {r}_{i} ) = {m}_{i} , \\ ( {r}_{i} , r ) & otherwise\end{matrix} .$$

The first argument in Dᵢ is referred to as the stage duration and denoted as Dᵢ¹. The second argument in Dᵢ is referred to as the stage type (map or reduce) and denoted as Dᵢ². In the above, (mᵢ, m), mᵢ represents the duration of the map stage, and m denotes that the type of the stage is a map stage. Similarly, in (rᵢ, r), rᵢ represents the duration of the reduce stage, and r denotes that the type of the stage is a reduce stage.

An example pseudocode of the Johnson scheduling technique is provided below.

Johnson scheduling technique

Input: A set [symbol] of n MapReduce jobs. Dᵢ is the attribute of job Jᵢ as defined
above.
Output: Schedule σ (order of execution of jobs).

| | |
|---|---|
| 1: | Sort the set [symbol] of jobs into an ordered list L using their stage duration |
| | attribute Dᵢ¹ |
| 2: | head ← 1, tail ← n |
| 3: | for each job Jᵢ in L do |

| | |
|---|---|
| 4: | if Dᵢ² = m then |

| | |
|---|---|
| 5: | // Put job Jᵢ from the front |
| 6: | σ_{head} ← Jᵢ, head ← head + 1 |

| | |
|---|---|
| 7: | Else |

| | |
|---|---|
| 8: | // Put job Jᵢ from the end |
| 9: | σₜₐᵢₗ ← Jᵢ, tail ← tail − 1 |

| | |
|---|---|
| 10: | end if |

| | |
|---|---|
| 11: | end for |

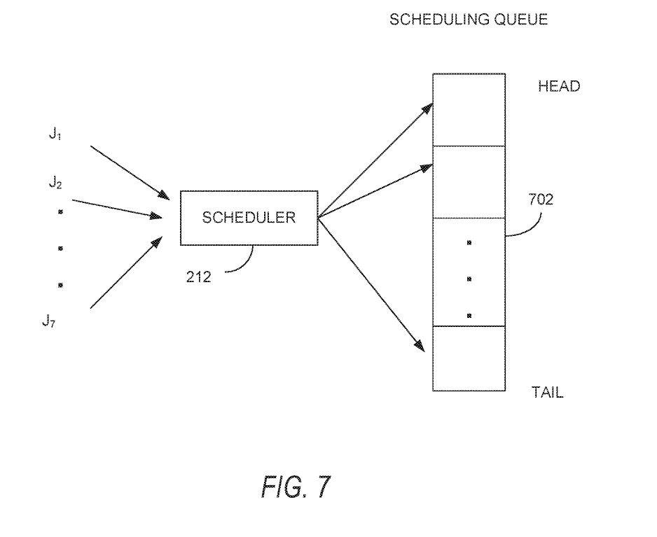

The Johnson scheduling technique (as performed by the scheduler 212) depicted above is discussed in connection with FIG. 7, which shows an scheduling queue 702 that includes a number of entries in which jobs of the set [symbol] of jobs are to be placed. Once the scheduling queue 702 is filled, then the jobs in the scheduling queue 702 can be executed in an order from the head (head) of the queue 702 to the tail (tail) of the scheduling queue 702. At line 2 of the pseudocode, head is initialized to the value 1, and tail is initialized to the value n (n is the number of jobs in the set [symbol] ).

Line 1 of the pseudocode sorts the n jobs of the set [symbol] in the ordered list L in such a way that job Jᵢ precedes job Jᵢ₊₁ in the ordered list L if and only if min(mᵢ, rᵢ)≦min(mᵢ₊₁, rᵢ₊₁). In other words, the jabs are sorted using the stage duration attribute Dᵢ¹ in Dᵢ (stage duration attribute Dᵢ¹ represents the smallest duration of the two stages).

The pseudocode takes jobs from the ordered list L and places them into the schedule σ(represented by the scheduling queue 702) from the two ends (head and tail), and then proceeds to place further jobs from the ordered list L in the intermediate positions of the scheduling queue 702. As specified at lines 4-6 of the pseudocode, if the stage type Dᵢ² in Dᵢ is m, i.e., Dᵢ² represents the map stage type, then job Jᵢ is placed at the current available head of the scheduling queue 702 (as represented by head, which is initiated to the value 1. Once job Jᵢ is placed in the scheduling queue 702, the value of head is incremented by 1 (so that a next job would be placed at the next head position of the scheduling queue 702).

As specified at lines 7-9 of the pseudocode, if the stage type Dᵢ² in Dᵢ is not m, then job Jᵢ is placed at the current available tail of the scheduling queue 702 (as represented by tail, which is initiated to the value n. Once job Jᵢ is placed in the scheduling queue 702, the value of tail is incremented by 1 (so that a next job would be placed at the next tail position of the scheduling queue 702).

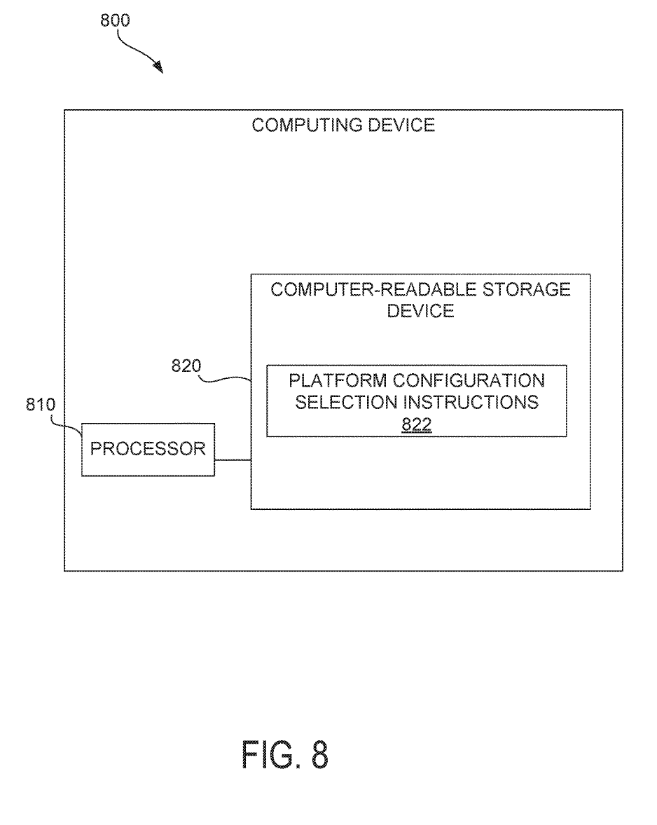

FIG. 8 is a block diagram of a computing device 800 capable of selecting a platform configuration, according to one example. The computing device 800 includes, for example, a processor 810, and a computer-readable storage device 820 including platform configuration selection instructions 822. The computing device 800 may be, for example, a memory node, a processor node, (see FIG. 1) or any other suitable computing device capable of providing the functionality described herein.

The processor 810 may be a central processing unit (CPU), a semiconductor-based microprocessor, a graphics processing unit (GPU), other hardware devices or circuitry suitable for retrieval and execution of instructions stored in computer-readable storage device 820, or combinations thereof. For example, the processor 810 may include multiple cores on a chip, include multiple cores across multiple chips, multiple cores across multiple devices, or combinations thereof. The processor 810 may fetch, decode, and execute one or more of the platform configuration selection instructions 822 to implement methods and operations discussed above, with reference to FIGS. 1-6. As an alternative or in addition to retrieving and executing instructions, processor 810 may include at least one integrated circuit (“IC”), other control logic, other electronic circuits, or combinations thereof that include a number of electronic components for performing the functionality of instructions 822.

Computer-readable storage device 820 may be any electronic, magnetic, optical, or other physical storage device that contains or stores executable instructions. Thus, computer-readable storage device may be, for example, Random Access Memory (RAM), an Electrically Erasable Programmable Read-Only Memory (EEPROM), a storage drive, a Compact Disc Read Only Memory (CD-ROM), non-volatile memory, and the like. As such, the machine- readable storage device can be non-transitory. As described in detail herein, computer-readable storage device 820 may be encoded with a series of executable instructions for selecting a platform configuration in light of a degraded makespan.

As used herein, the term “computer system” may refer to one or more computer devices, such as the computer device 800 shown in FIG. 8. Further, the terms “couple,” “couples,” “communicatively couple,” or “communicatively coupled” is intended to mean either an indirect or direct connection. Thus, if a first device, module, or engine couples to a second device, module, or engine, that connection may be through a direct connection, or through an indirect connection via other devices, modules, logic, engines and connections. In the case of electrical connections, such coupling may be direct, indirect, through an optical connection, or through a wireless electrical connection.

While this disclosure makes reference to some examples, various modifications to the described examples may be made without departing from the scope of the claimed features.

What is claimed is:

1. A method comprising:
obtaining, by a computing system, a job profile of a prospective job, a normal makespan goal, and a degraded makespan goal, the job profile including a job trace summary;
generating, by the computing system, a simulation result of the prospective job based on a first simulation of the job trace summary on a platform configuration and a second simulation of the job trace summary on a degraded version of the platform configuration, the simulation result including a predicted normal makespan and a predicated degraded makespan; and
communicating, by the computing system, a purchasing option that selects the platform configuration, the purchasing option selects the platform configuration based on the predicted normal makespan satisfying the normal makespan goal and the predicted degraded makespan satisfying the degraded makespan goal.

2. The method of claim 1, further comprising:
generating an additional simulation result of the prospective job based on a third simulation of the job trace summary on another platform configuration and a fourth simulation of the job trace summary on a degraded version of the another platform configuration, the additional simulation result including another predicted normal makespan and another predicated degraded makespan; and
selecting the simulation result to use in the purchasing option based on a comparison between a cost associated with the simulation result and a cost associated with the additional simulation result.

3. The method of claim 2, wherein the platform configuration and the another platform configuration differ in a cluster size.

4. The method of claim 2, wherein the platform configuration and the another platform configuration differ in an instance type.

5. The method of claim 1, further comprising:
generating an additional simulation result of the prospective job based on a third simulation of the job trace summary on another platform configuration and a fourth simulation of the job trace summary on a degraded version of the another platform configuration, the additional simulation result including another predicted normal makespan and another predicated degraded makespan; and
selecting the simulation result to use in the purchasing option based on a comparison between the predicted normal makespan and the another predicted normal makespan.

6. The method of claim 1, further comprising generating the degraded version of the platform configuration, generating the degraded version of the platform configuration includes decrementing a cluster size associated with the platform configuration.

7. The method of claim 1, further comprising: responsive to detecting a tenant activation of the purchasing option, provisioning computing resources within a cloud infrastructure according to the platform configuration.

8. The method of claim 1, wherein the normal makespan goal and the degraded makespan goal are inputs supplied by a tenant system.

9. The method of claim 1, wherein the prospective job is a MapReduce job.

10. The method of claim 1, further comprising generating a schedule that lists an execution order for the prospective job and other prospective jobs, wherein the first simulation and the second simulation operate according to the schedule.

11. A system comprising:
a processor to:
obtain job profiles of prospective jobs in a workload, a normal makespan goal, and a degraded makespan goal, the job profiles including job trace summaries;
generate a schedule of the workload using the job trace summaries and a platform configuration;
aggregate a simulation result of an execution of the workload according to the schedule and the platform configuration and a simulation result of another execution of the workload according to the schedule and a degraded version of the platform configuration, the aggregated simulation result including a predicted normal makespan and a predicated degraded makespan;
select the platform configuration based on the predicted normal makespan satisfying the normal makespan goal and the predicted degraded makespan satisfying the degraded makespan goal, and
provision computing resources from a cloud infrastructure system according to the selected platform configuration.

12. The system of claim 11, wherein the processor to select the aggregated simulation result from additional aggregated simulation results based on a comparison of a cost associated with the aggregated simulation result and costs associated with the additional aggregated simulation results.

13. The system of claim 12, wherein the processor further to remove aggregated simulation results from the additional aggregated simulation results based the removed aggregated simulation results including predicted normal makespans that violate the normal makespan goal.

14. The system of claim 12, wherein the processor further to remove aggregated simulation results from the additional aggregated simulation results based the removed aggregated simulation results including predicted degraded makespans that violate the degraded makespan goal.

15. A computer-readable storage device comprising instructions that, when executed, cause a processor of a computer device to:
receive, from a tenant system, a job profile of a prospective job, a normal makespan goal, and a degraded makespan goal, the job profile including a job trace summary;
generate a predicted normal makespan and a predicated degraded makespan for a platform configuration based on executing a first simulation of the prospective job executing on computing resources according to the platform configuration and a second simulation of the prospective job executing on computing resources according to a degraded version of the platform configuration; and
select the platform configuration based on the predicted normal makespan satisfying the normal makespan goal and the predicted degraded makespan satisfying the degraded makespan goal.
